(19) United States
(12) Patent Application Publication
(10) Pub. No.: US 2012/0275961 A1
(43) Pub. Date: Nov. 1, 2012

(54) Fluid Separation Systems And Methods

(76) Inventors: Christopher K. Morgan, Pearland, TX (US); Alan M. Braaten, Kingwood, TX (US)

(21) Appl. No.: 13/500,769

(22) PCT Filed: Nov. 13, 2009
(86) PCT No.: PCT/US09/64429

§ 371 Date: Jun. 6, 2012

(51) Int. Cl. B01D 45/08; B01J 19/00

(52) U.S. Cl. 422/131; 55/462; 55/459.1; 55/440; 95/272

(57) ABSTRACT

Systems and methods for separating particles from fluids are provided. The system comprises a vessel with a fluid inlet and a fluid outlet and a baffle assembly located within the vessel. The baffle assembly has a plurality of baffles that can provide a change in direction to fluid entering the vessel thereby separating particles. During shut-down of a polymerization reactor, reaction mixture is discharged to a separation system where polymer particles are removed from the mixture prior to being released into the atmosphere.

### CROSS-REFERENCE TO RELATED APPLICATIONS

This application relates to PCT Application No. PCT/US2008/087501 entitled “High Pressure Polymerization Process,” filed on Dec. 18, 2008, and PCT Application No. PCT/US2009/050491 entitled “High Pressure Radical Polymerization Process,” filed on Jul. 14, 2009. These applications are incorporated by reference herein in their entirety.

### FIELD OF THE INVENTION

This disclosure relates to fluid separation systems and methods. More particularly, this invention relates to systems and methods for separating polymer particles from reaction mixtures in polymerization processes.

### BACKGROUND OF THE INVENTION

Polymerization reactors convert relatively low cost olefin monomers (e.g., ethylene, optionally in combination with one or more comonomers) into valuable polyolefin product (e.g., polyethylene).

The reactors are generally operated at relatively high pressure (e.g., 200 to 310 MPa) and relatively high temperature (e.g., 150 to 450° C.). The reaction is highly exothermic. If the reaction mixture overheats, the olefins will decompose into carbon, hydrogen, and methane. Moreover, excessive temperature and/or pressure can present safety concerns. For these reasons, it is important to conduct the polymerization in a controlled manner and, if necessary, implement emergency shut-down of the reactor.

Emergency shut-down generally requires relieving the temperature and pressure conditions within the reactor by venting the reactor contents (e.g., a mixture of unreacted components and polymer particles) into the atmosphere.

It would be desirable to have a system and method that reduces, or effectively eliminates, the emission of polymer particles into the atmosphere during reactor shut-down.

### SUMMARY OF THE INVENTION

In one aspect, this disclosure relates to systems for separating particles from a fluid. The system comprises: (i) a vessel having a fluid inlet and a fluid outlet; and (2) a baffle assembly located within the vessel. The baffle assembly has a plurality of baffles that can provide a change in direction to fluid entering the vessel.

In another aspect, this disclosure relates to methods for separating particles (e.g., polymer) from a reaction mixture during shut-down of a polymerization reactor. The method comprises: (i) opening a valve in the polymerization reactor; and (ii) discharging at least a portion of the reaction mixture into a separation system. The separation system may comprise a vessel having a fluid inlet and a fluid outlet and a baffle assembly concentrically positioned within the vessel. The baffle assembly may comprise a plurality of baffles that form an annular ring. The plurality of baffles may be axially extending. Each of the plurality of baffles may be oriented in the same direction as fluid entering the vessel.

In one embodiment, the fluid inlet can introduce fluid substantially tangentially to the wall of the vessel.

In one embodiment, the fluid comprises a polymer, such as polyethylene, suspended therein.

These and other features, aspects, and advantages of the present disclosure will become better understood with regard to the following description and appended claims.

### BRIEF DESCRIPTION OF THE FIGURES

FIGS. 1A-1C illustrate exemplary embodiments of various separation systems;

FIG. 2 illustrates a top planar view of an exemplary embodiment of a baffle assembly within a separation system;

FIG. 3 illustrates an exemplary embodiment of a baffle assembly having a baffle support and a barrier;

FIG. 4 illustrates an exemplary embodiment of a separation system having a baffle assembly insert; and

FIG. 5 illustrates a schematic of an exemplary embodiment of a polymerization system comprising a separation system.

### DETAILED DESCRIPTION OF THE INVENTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

That said, described herein are systems and methods for separating particles (e.g., solid polymer) from fluids, particularly during shut-down of polymerization reactors. Exemplary separation systems comprise: 1) a vessel having a fluid inlet and a fluid outlet; and (2) a baffle assembly.

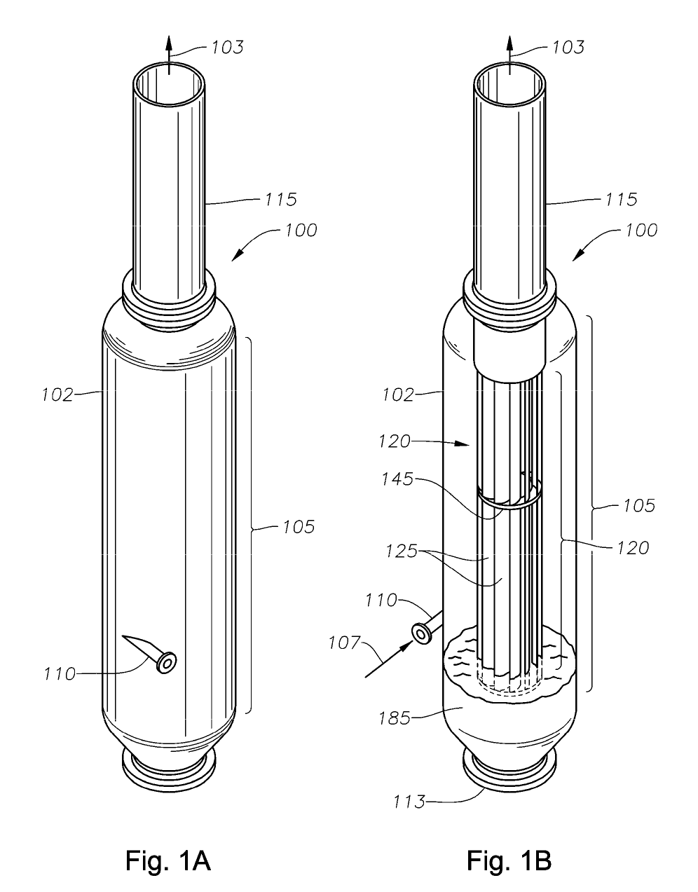

The vessel may be any structure sufficient to contain fluid within. FIGS. 1A-1C illustrate exemplary embodiments of separation system 100 comprising vessel 105. As shown, vessel 105 is cylindrical. However, the vessel may be any shape (e.g., rectangular, circular and/or the like). Moreover, the vessel may be any size sufficient to accommodate the flow of fluid discharged from a reactor system during shut-down. In FIGS. 1A-1C, vessel 105 is substantially vertically oriented. In other embodiments, the vessel may be substantially horizontally oriented or in another orientation. The vessel may be made of any suitable material, such as steel.

The vessel further comprises a fluid inlet sufficient to deliver fluid into the vessel. In accordance with various exemplary embodiments, the fluid inlet introduces the fluid into the vessel at a desired trajectory. For example, the fluid inlet may introduce fluid toward, or substantially tangentially to, the wall of the vessel. FIGS. 1A to 1C illustrate fluid inlet 110 that is substantially tangential to wall 102 of vessel 105.

In various exemplary embodiments, the fluid inlet is located in the bottom half of the vessel. For example, a vessel having a height Hv may have a fluid inlet located at a height of about 0.1Hv to about 0.7Hv, or about 0.4Hv, from the bottom of the vessel.

The vessel further comprises a fluid outlet sufficient to discharge fluid. FIGS. 1A to 1C illustrate vessel 105 comprising fluid outlet 115. As shown, fluid outlet 115 may be located at the top of vessel 105 to facilitate substantially vertical fluid discharge.

In accordance with various exemplary embodiments, the diameters of the fluid inlet and fluid outlet may be sized to control the speed of entry and/or exit of the fluid. For example, the diameter of the fluid inlet may be relative small (e.g., about 0.04 to about 0.3 m) to introduce fluid into the vessel at a relatively high speed and/or the diameter of the fluid outlet may be relatively large (e.g., about 0.5 to about 1.5 m) to discharge fluid at a relatively low speed.

The fluid may be any composition containing particles, whether in solid, gas, or aqueous form. For example, the fluid may comprise any known or hereinafter devised polymerization reaction components in the gas phase (e.g., one or more of olefin monomers such as ethylene-derived units or propylene- derived units, comonomers such as a-olefins, solvents, initiators, catalysts, additives, hydrogen, and/or the like) in combination with one or more particles (e.g., polymers such as those containing ethylene-derived units or propylene-derived units) suspended therein (e.g., a polyolefin, such as polyethylene or polypropylene).

The separation system further comprises a baffle assembly. The baffle assembly may be any device, structure or system that provides a change in direction to fluid entering the vessel. The change in direction: (1) acts as a separating mechanism to remove polymer and other particles from the fluid; and/or (2) lengthens the resident time of the fluid within the vessel, thereby allowing more time for polymer to deposit onto a surface within the vessel. In various embodiments, the baffle assembly further provides a guided flow path for fluid within the vessel.

In an exemplary embodiment, the baffle assembly comprises a plurality of baffles. By way of example, FIGS. 1B and 1C illustrate exemplary embodiments of baffle assembly 120 having a plurality of baffles 125. As shown, baffles 125 are axially extending and form an annular ring. As used herein “axially extending” means extending along the length of the vessel. (e.g., downwardly from the top portion of vessel 105). The annular ring has an inner diameter and an outer diameter. In various embodiments, the inner diameter of the annular ring forms a conduit with fluid outlet 115 to provide a guided flow path for fluid 103 to exit separation system 100 (e.g., into the atmosphere, another separation system or a storage container). In one embodiment, the baffle assembly is positioned centrally (or concentrically) within vessel 105. In one embodiment, each of the plurality of baffles is stationary.

In various embodiments, the plurality of baffles is non-motorized, i.e., operable to rotate but not rotated under motor power.

In various embodiments, the baffle assembly extends at least a distance of about 0.6Hv to about 0.9Hv from the top of the vessel, for a vessel of height Hv. The conduit (ID of the baffle assembly) may have a diameter Dc of about 0.15Dv to about 0.6Dv, for a vessel having a diameter Dv.

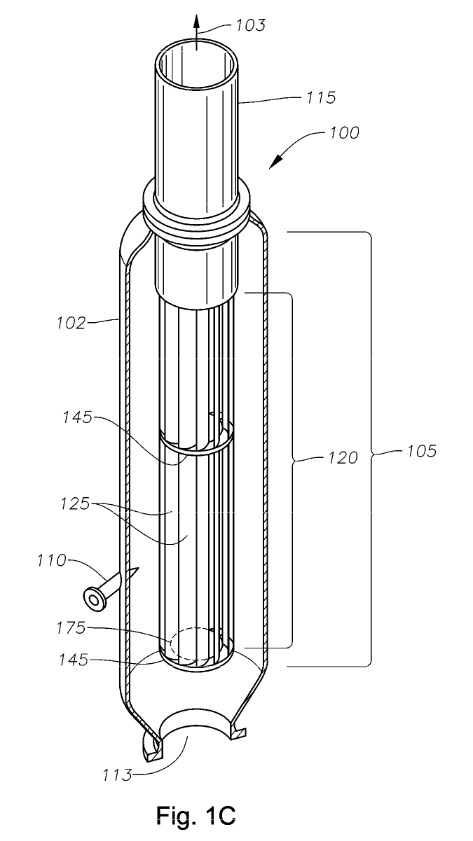

In accordance with various exemplary embodiments, each of the plurality of baffles is oriented in the same direction as fluid entering the vessel via the fluid inlet. As used herein, the phrase “in the same direction as fluid entering the vessel” means at an angle between 0 and 90 degrees relative to the direction of entry of the fluid entering the vessel. For example, FIG. 2 illustrates plurality of baffles 225 oriented in the same direction as fluid 230 introduced into vessel 205 via fluid inlet 210. Without wishing to be limited to any particular theory of operation, the fluid entering the vessel is deflected off the baffles toward the vessel wall. The change in direction inhibits immediate discharge of fluid from the vessel and causes polymer to deposit on the wall of the vessel and the baffle surfaces.

In one embodiment, each of the plurality of baffles is substantially rectangular. Moreover, each of the plurality of baffles may have a length of about 0.6Hv to about 0.9Hv m and/or a width of about 0.1 to about 0.5 m. In one embodiment, each of the plurality of baffles is curved along its width to facilitate deflection of the fluid. For example, FIG. 2 illustrates a plurality of baffles curved from the inner diameter 235 of the baffle assembly to the outer diameter 240 the of baffle assembly in the same direction as the direction fluid 230 enters vessel 205 via fluid inlet 210.

As shown in FIG. 2, the plurality of baffles 225 are spaced apart to allow fluid to enter conduit 275 formed by the inner diameter 235 of the baffle assembly after being initially deflected. For example, the baffles may each be separated by a distance of about 0.05 to about 0.5 m. Conduit 275 directs the fluid to the fluid outlet (not shown in FIG. 2) to be discharged from separation system 200.

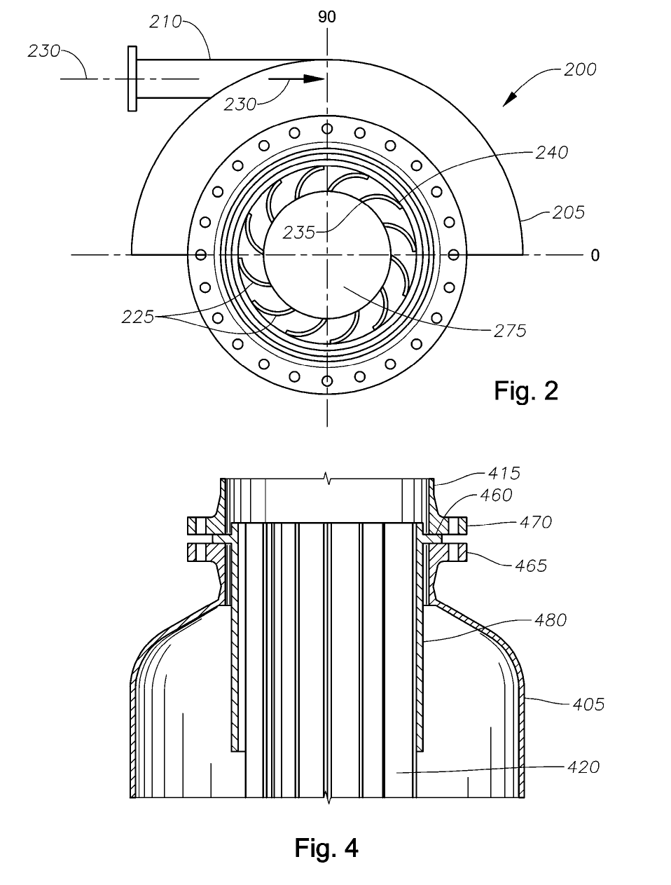

In various embodiments, the baffle assembly comprises one or more baffle supports. The baffle support may be any device, structure or system that provides additional stabilization along the length of the baffle assembly. FIGS. 1B, 1C and 3 illustrate baffle assembly 120/320 having baffle supports 145/345 located substantially perpendicular to plurality of baffles 125/325. In various embodiments, and as shown in FIG. 3, the top of baffle assembly 320 may not have a support, or the support may be located outside baffles 325, so as to not restrict discharge of fluid 303 through fluid outlet 315.

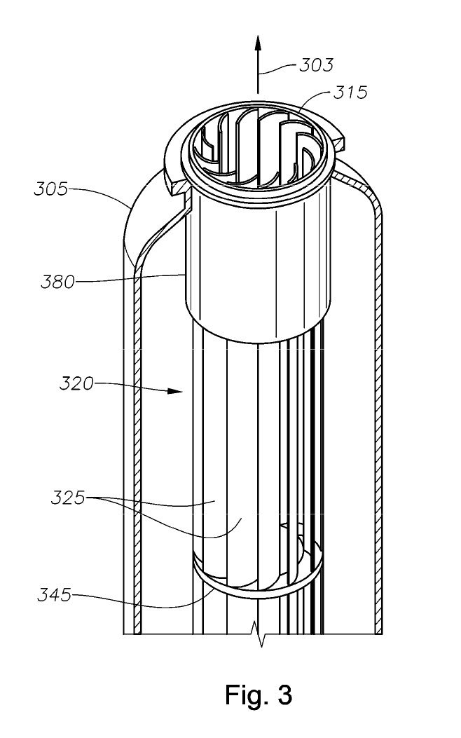

In various exemplary embodiments, the baffle assembly is integrally formed with the vessel. In other embodiments, the baffle assembly is a separately-formed insert that may be retrofitted to an existing vessel or separation system. The insert may be attached to the vessel using any known or hereinafter devised system or method. For example, as illustrated in FIG. 4, baffle assembly insert 420 may comprise flange 460 that may be secured to vessel 405 and fluid outlet 415 between vessel flange 465 and outlet flange 470.

In various embodiments, and as shown in FIG. 1C, baffle assembly 120 may comprise opening 175 to allow fluid to bypass baffle assembly 120 in the event baffles 125 become restricted.

In various embodiments, the separation system further comprises a barrier to prevent fluid from prematurely exiting the system. FIGS. 3 and 4 illustrate exemplary barrier 380/480 restricting entry of the fluid into the top portion of baffles 325/425. Instead, the fluid contacts barrier 380/480 is forced downward within vessel 305/405.

In various exemplary embodiments, the separation system further comprises a liquid reservoir within the vessel. For example, as shown in FIG. 1B, the bottom of vessel 105 may comprise opening 113 or one or more nozzles may be located on the side of the vessel to permit entry of the reservoir liquid. Any liquid, such as water, may be used. In various embodiments, the liquid contained in the reservoir is relatively cool compared to the fluid (e.g., about 5° C. to about 40° C.), causing the fluid contacting the water to precipitate the polymer out. The liquid may be filled to any desired height. For example, in the embodiment illustrated in FIG. 1B, the bottom of baffle assembly 120 is submerged beneath reservoir liquid 185 to prevent particles from bypassing baffle assembly 120 and to dampen acoustic vibration resulting from the exiting fluid. In one embodiment, the liquid level is maintained below inlet 110. The liquid level may be maintained and monitored using appropriate level devices via nozzles in side of the vessel.

In various embodiments, the reservoir liquid may be drained from the vessel and/or may undergo further processing to remove the particles. The reservoir may be recharged.

In various embodiments, one or more separation systems may be employed in parallel or in series to further control and reduce the amount of polymer released into the atmosphere.

In operation, and with reference to FIG. 1B, fluid stream 107 enters separation system through fluid inlet 110 at an angle substantially tangential to wall 102 of vessel 105. Plurality of baffles 125 of baffle assembly 120 deflects the fluid stream radially outward to wall 102 of vessel 105. The change in direction of the fluid stream causes polymer to deposit on baffles 125, the inner wall of vessel 105, and in liquid in reservoir 185. Upon build up of the fluid stream within the vessel, the fluid enters the inner diameter of baffle assembly 120 via spaces between baffles 125. Once inside the inner diameter, fluid 103 flows upward and is released to the atmosphere via fluid outlet 115.

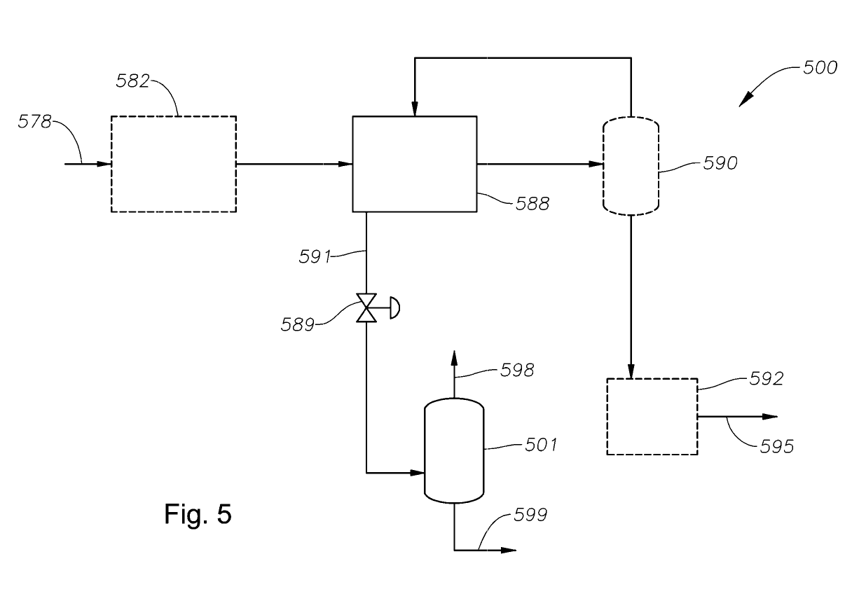

In various embodiments, the invention relates to a process for shutting down a polymerization system (e.g., emergency shut down due to excess pressure and/or temperature). With reference to FIG. 5, polymerization system 500 comprises reactor 588 and separation system 501 located downstream. In various embodiments, the reactor is a high pressure polymerization reactor (e.g., a tubular, autoclave or slurry loop reactor). It will be understood that polymerization system 500 may further comprise any number of additional components to facilitate the polymerization process (e.g., compressors 582, separators 590, dryers 592, etc.).

In operation, and with continued reference to FIG. 5, feed stream 578 comprising an olefin monomer (e.g., ethylene or propylene) along with component(s) needed for polymerization (e.g., initiators (e.g., peroxides), catalysts (e.g., Ziegler/Natta or single site catalysts) and/or the like), and optionally, one or more components that are polymerizable therewith (e.g., a comonomer), is supplied to reactor 588 to form polymer 595 (e.g., polyethylene or polypropylene). The reactor operating pressure is typically about 120 to about 310 MPa, or about 200 to 250 MPa and the reactor operating temperature is typically about 225 to about 375° C., or about 250 to 350° C.

In the event the reactor needs to be shut down (e.g., it exceeds a predetermined pressure or temperature), feed stream 578 is stopped and the pressure within reactor 588 is let down by opening one or more valves 589, which transfers reaction mixture 591 comprising a mixture of gas and polymer particles to separation system 501. As used herein, “opening one or more valves” includes manual opening as well as automatic actuation and the like. Upon entry into separation system 501, the fluid mixture contacts the baffle assembly which separates the polymer before releasing gas 598 into the atmosphere. Residual polymer 599 can then be removed from separation system 501.

### Example (Prophetic)

The advantages of the compositions described herein will now be further illustrated with reference to the following non-limiting Example 1.

### Example 1

Polyethylene is manufactured in a tubular reactor (vol. 500 L) at a pressure of about 300 MPa and a temperature of 310° C. The reactor is equipped with valve that opens when reactor shut-down is needed (e.g., predetermined reactor conditions, such as pressure or temperature limits, are exceeded). Upon activation of the valve, the reactor contents are released into a separation system (vol. 8000 L). The fluid inlet is oriented tangentially to the wall of the vessel of the separation system. The baffle assembly (e.g., annular ring) are axially extending such that the inner diameter of the annular ring forms a conduit with the fluid outlet. The individual baffles of the baffle assembly curved along their width from the inner diameter of the baffle assembly to the outer diameter of the baffle assembly in the same direction as fluid entering the vessel. It is expected that for 100 kg of polymer in the reactor, 80 kg of polymer will be collected in the separation system and 20 kg of polymer will be discharged into the atmosphere (polymer retention of 80%).

The embodiments and examples set forth herein are presented to best explain the present invention and its practical application and to thereby enable those skilled in the art to make and use the invention. However, those skilled in the art will recognize that the foregoing description have been presented for the purpose of illustration and example only. The description set forth is not intended to be exhaustive or to limit the invention to the precise form disclosed. Many modifications and variations are possible in light of the above teaching without departing from the spirit and scope of the claims.

What is claimed is:

1-29. (canceled)

30. A system for separating particles from a fluid comprising:
a. a vessel having a fluid inlet, a fluid outlet and a cooling liquid reservoir; and
b. a baffle assembly located within the vessel, the baffle assembly comprising a plurality of stationary baffles that change the direction of fluid entering the vessel.

31. The system according to claim 30, wherein the plurality of baffles are axially extending.

32. The system according to claim 1, wherein the plurality of baffles form an annular ring having an inner diameter and an outer diameter.

33. The system according to claim 32, wherein the inner diameter of the annular ring forms a conduit with the fluid outlet to allow fluid to exit the system.

34. The system according to claim 1, wherein the baffle assembly is substantially concentrically positioned within the vessel.

35. The system according to claim 1, wherein the plurality of baffles each has a width of about 0.1 to about 0.5 m.

36. The system according to claim 1, wherein the plurality of baffles each has a length of about 0.6Hv to about 0.9Hv, where Hv is the height of the vessel.

37. The system according to claim 1, wherein each of the plurality of baffles is curved from the inner diameter of the annular ring to the outer diameter of the annular ring.

38. The system according to claim 1, wherein each of the plurality of baffles is separated by a distance of about 0.05 to about 0.50 m.

39. The system according to claim 1, wherein the baffle assembly further comprises at least one baffle support oriented substantially perpendicular to the plurality of baffles.

40. The system according to claim 1, wherein the baffle assembly further comprises an opening at the end to allow fluid to bypass the baffle assembly.

41. The system according to claim 1, wherein the vessel is cylindrical.

42. The system according to claim 41, wherein the vessel has a diameter Dv and the conduit has a diameter Dc, where Dc is in the range of 0.15Dv to 0.60Dv.

43. The system according to claim 1, wherein the fluid inlet can introduce a fluid into the vessel at an orientation that is substantially tangential to the wall of the vessel.

44. The system according to claim 1, wherein the fluid inlet is substantially tangential to the wall of the vessel.

45. The system according to claim 1, wherein each of the plurality of baffles is oriented in the same direction as the fluid entering the vessel.

46. The system according to claim 1, wherein the particles contain polymer.

47. A method for reducing the pressure in a polymerization reactor, the process comprising:
a. opening a valve in the polymerization reactor; and
b. discharging the fluid located within the polymerization reactor into the system of claim 1.

48. A method for separating particles from a reaction mixture during shut-down of a polymerization reactor comprising:
a. letting down the polymerization reactor by opening one or more valves; and
b. discharging at least a portion of the reaction mixture from the polymerization reactor to a separation system, wherein the separation system comprises:
a vessel having a fluid inlet, a fluid outlet and a cooling liquid reservoir; and
a baffle assembly comprising plurality of baffles that form an annular ring are axially extending and wherein each of the plurality of baffles is oriented in the same direction as fluid entering the vessel.

49. A polymerization system comprising:
a. a tubular polymerization reactor operable at about 120 to about 310 MPa and about 225 to about 375° C.; and
b. a separation system located downstream of the polymerization reactor, the separation system comprising:
i. a vessel having a fluid inlet, a fluid outlet and a cooling liquid reservoir; and
ii. a baffle assembly located within the vessel, the baffle assembly comprising a plurality of stationary baffles that change the direction of fluid entering the vessel.
